(19) United States
(12) Patent Application Publication
(10) Pub. No.: US 2024/0286268 A1
(43) Pub. Date: Aug. 29, 2024

(54) Counterbalance Arm Support Arrangemet for Load-Bearng Tools

(71) Applicant: Peak Degrees Holdings LLC, Trophy Club, TX (US)

(72) Inventor: Christopher Pesek, Trophy Club, TX (US)

(21) Appl. No.: 18/418,072

(22) Filed: Jan. 19, 2024

Related U.S. Application Data
(60) Provisional application No. 63/448,168, filed on Feb. 24, 2023.

(51) Int. Cl. B25G 1/10; A01K 97/00; B25J 1/04

(52) U.S. Cl. CPC B25G 1/102; A01K 97/00; B25J 1/04

(57) ABSTRACT

An arm support arrangement in line with a load-bearing tool counterbalances a load associated with the load-bearing tool. The arm support arrangement includes a tubular body having at least three bends defining two planes and terminating in a tool-engaging end. A first of the two planes has an upward slanting arm-engaging angled portion opposite the tool-engaging end. The arm-engaging angled portion has one of the bends disposed between a pair of support segments. The bends cooperate to orient an axis of a user's forearm toward the tool-engaging end. The tool-engaging end is in line with a load-bearing tool at least a weight of which is directed downwardly such that the arm-engaging angled portion is directed upwardly toward the user's forearm about a fulcrum point intermediate the tool-engaging end and the arm-engaging angled portion. The arm support arrangement counterbalances a load associated with the load-bearing tool.

### PRIOR HISTORY

This application claims the benefit of U.S. Provisional Patent Application No. 63/448,168 filed in the United States Patent and Trademark Office on 24 Feb. 2023, the specifications and illustrative support for which are hereby incorporated by reference.

### FIELD OF THE INVENTION

The present invention relates generally to a hand tool apparatus, and more particularly to an arm support arrangement for counterbalancing loads associated with the distal ends of load-bearing hand tools.

### BRIEF DESCRIPTION OF THE PRIOR ART

Grabber or reacher tools are known in the art and generally known as reaching aids. Other commonly used descriptors for the devices or tools are grabber reacher aids, trash grabbers, trash picker tools, plier tools, and the like. In all iterations of these types of devices, the load or weight of the target object is transferred into the handle mechanism so that the user can bring the object closer to his or her person to manually engage the reached/grabbed object. The object load or weight, however, is oftentimes stressful or may cause undue strain at the user's hand and peripheral anatomy causing discomfort or injury at the user's hand and peripheral anatomy.

These same principles are applicable to any number of load-bearing tools with distally extended portions as variously exemplified by fishing rods and fishnet ensembles. The prior art thus perceives a need for an arm support arrangement operable to shift a tool load away from the relative more fragile hand and radiocarpal joint anatomy to the relatively more robust anchor structure provided by the user's forearm. The presently disclosed subject matter attempts to provide such a solution as summarized in more detail hereinafter, as particularly incorporated into a reacher/grabber tool and a fishing tool as illustrated and summarized in more detail below.

### SUMMARY OF THE INVENTION

The presently disclosed subject matter essentially provides an arm support arrangement. The arm support arrangement is coextensive with or otherwise attachable to or in line with a load-bearing tool for counterbalancing a load associated with the load-bearing tool at a user's forearm. The arm support arrangement according to the presently disclosed subject matter comprises a tubular body having at least three bends defining two planes and terminating in a tool-engaging end. Stated another way, the arm support arrangement comprises a tubular body having an S-shape in three dimensions and comprises an upward slanting arm-engaging angled portion and a support-to-fulcrum angled portion, which portions extend in the intersecting first and second planes.

A first of the two planes comprises an upward slanting arm-engaging angled portion opposite the tool-engaging end. The arm-engaging angled portion comprises one of the bends disposed between a pair of support segments. The bends cooperate to orient an axis of a user's forearm toward the tool-engaging end, which tool-engaging end is coextensive with or attachable to or in line with a load-bearing tool, at least a weight of which is directed downwardly such that the arm-engaging angled portion is directed upwardly toward the user's forearm about a fulcrum point intermediate the tool-engaging end and the arm-engaging angled portion.

In some embodiments, the arm support arrangement comprises a handle portion at the fulcrum point. In some embodiments, the arm support arrangement comprises a fourth bend intermediate the fulcrum point and the tool-engaging end for orienting an axis of the tool-engaging end in parallel relation to the axis of the user's forearm. In some embodiments, the arm-engaging angled portion extends in a first plane and the support-to-fulcrum extends in a second plane, which first and second planes are angled relative to one another. In some embodiments, the first plane extends obliquely relative to the axis of the user's forearm such that the first plane extends through an end of the handle portion.

In some embodiments, the arm-engaging angled portion comprises a first support segment, a second support segment and a radiused support segment extending intermediate the first and second support segments. The radiused support segment is configured for engaging a first portion of the user's forearm. In some embodiments, the first and second support segments flank outer portions of the user's forearm for further engaging outer portions of the user's forearm and increasing the support function of the arm-engaging angled portion. In some embodiments, the support-to-fulcrum angled portion comprises a first angle segment, a second angle segment and a radiused angle segment extending intermediate the first and second angle segments. In some embodiments, the support-to-fulcrum angled portion is connected to the arm-engaging angled support angled portion by way of a radiused central segment.

The arm support arrangement according to the presently disclosed subject matter is usable in combination a select load-bearing tool, which select load-bearing tool is selected from the group consisting of a grabber tool and a fishing tool, the latter of which may include a fishing rod or a fishnet tool. The grabber tool generally enables a user to grab objects in a manner akin to those briefly described above. As earlier described, similar tools are known in the art, and are commonly referred to as grabber tools or reacher tools. The distal ends of these types of grabber tools are generally outfitted with some type of pincher mechanism that is operable to pinch or grab an object so that the user may then reorient the tool and bring the grabbed object closer to the user's person without the need to bend, stand, reach, or climb upon secondary support structures to reach the targeted object.

As further introduced above, state-of-the-art tools of this type are typically configured such that the weight of the object(s) so grabbed are directed into the user's hand and radiocarpal joint by way of the elongated arm portion of the tools, thereby placing stress or strain upon the hand and/or radiocarpal joint causing discomfort or possible injury to the user in many instances. The grabber tool apparatus incorporating the arm support arrangement according to the presently disclosed subject matter helps shift moment away from the user's hand, the radiocarpal joint and peripheral anatomy toward the user's arm, which anatomy is better suited to provide static equilibrium with less strain at the user's hand and radiocarpal joint. The shift of the balancing force thereby decreases discomfort at the hand/joint during usage and improving overall stability and usage of the grabber tool, particularly for user's who have experienced previous injury to the anatomical areas or users who have experienced a decline in structural strength in these anatomical areas, for example, the elderly.

In certain embodiments, the presently disclosed subject matter may be said to essentially teach or disclose a grabber tool for enabling a user to grab objects. The grabber tool according to the presently disclosed subject matter comprises a handle mechanism, and elongate arm portion, a pincher mechanism, and an arm support arrangement. The handle mechanism is configured to be ergonomically received in a user's hand and comprises an upper handle portion, a lower handle portion angled relative to the upper handle portion, and a trigger mechanism.

The elongate arm portion extends from a first handle end of the upper handle portion and comprises a proximal handle end and a distal pincher end. The pincher mechanism operably extends from the distal pincher end and is operatively coupled to the trigger mechanism via a force-transmitting mechanism as exemplified by a cable. The trigger mechanism is operable to selectively open and close the pincher mechanism via the force-transmitting mechanism. The arm support arrangement extends from the handle mechanism opposite the elongate arm portion for essentially providing a fulcrum point at the handle mechanism and is configured to engage a user's forearm for providing static equilibrium and countering a pincher mechanism load at the user's forearm and relieving stress at the user's hand.

In some embodiments, the elongate arm portion of the grabber tool may comprise or be outfitted with a pivot mechanism. The optional pivot mechanism enables the user to pivot the distal pincher end relative to the proximal handle end and collapse the grabber tool into a more compact or stowage configuration. In some embodiments, the pivot mechanism may comprise a loop member that extends outwardly from an outer surface thereof for enabling a user to support the grabber tool upon a hook member for storage. In some embodiments, the pivot mechanism may comprise opposed end-receiving portions extending from a centralized pivot mechanism, which end portions mate with distal and proximal arm portions of the elongate arm portion.

In some embodiments, the arm support arrangement may comprise a handle mating portion and the handle mechanism may comprise a support mating portion. The handle and support mating portions are matable in these embodiments for attaching the arm support arrangement to the handle mechanism. In some embodiments, the support mating portion is configured to receive the handle mating portion. In some embodiments, the handle and support mating portions each comprise at least one fastener-receiving aperture for receiving at least one fastener for fastening the arm support arrangement to the handle mechanism.

In some embodiments, the arm support arrangement is S-shaped in three dimensions and comprises an arm-engaging angled portion and a support-to-fulcrum angled portion. In some embodiments, the arm-engaging angled portion extends in a first plane and the support-to-fulcrum portion extends in a second plane, the first and second planes being angled relative to one another about a radiused central segment. In some embodiments, the first plane extends obliquely relative to the arm axis such that the first plane extends through a grip end of the upper handle portion. In some embodiments, the arm-engaging angled portion comprises a first support segment, a second support segment and a radiused support segment extending intermediate the first and second support segments, the radiused support segment being configured for engaging the user's forearm.

In some embodiments, the first and second support segments flank outer portions of the user's forearm for further engaging the user's forearm and increasing the support function of the arm-engaging angled portion. In some embodiments, the first and second support segments are angled 40 degrees with respect to one another. In some embodiments, at least a portion of the arm-engaging angled portion comprises a padded exterior surface for providing a padded interface intermediate the user's forearm and the arm-engaging angled portion for enhancing comfort at the user's forearm during use of the grabber tool. In some embodiments, the support-to-fulcrum angled portion comprises a first angle segment, a second angle segment and a radiused angle segment extending intermediate the first and second angle segments, the first and second angle segments being angled 30 degrees with respect to one another. In some embodiments, the support-to-fulcrum angled portion is connected to the arm support angled portion by way of a radiused central segment.

There is thus provided in accordance with another embodiment of the presently disclosed subject matter a grabber tool for enabling a user to grab objects. The grabber tool comprises a handle mechanism configured to be ergonomically received in a user's hand. The handle mechanism comprises a trigger mechanism configured to enable at least a portion of the user's hand to selectively direct at least a portion of the trigger mechanism in a first direction. The grabber tool further comprises an elongate arm portion. The elongate arm portion extends from the handle mechanism in a direction away from the first direction.

The grabber tool further comprises a pincher mechanism operably extending from the elongate arm portion. The pincher mechanism is operatively coupled to the trigger mechanism, which trigger mechanism is operable to selectively close the pincher mechanism. The grabber tool centrally further includes an arm support arrangement according to the presently disclosed subject matter. The arm support arrangement extends from the handle mechanism opposite the elongate arm portion for providing a fulcrum point at the handle mechanism and is configured to engage a user's forearm for providing static equilibrium and counterbalancing a grabbed object load at the user's forearm.

In some embodiments, the elongate arm portion may comprise a pivot mechanism, the pivot mechanism enables the user to pivot a distal arm portion relative to a proximal arm portion of the elongate arm portion to collapse the grabber tool into a more compact configuration. In some embodiments, the pivot mechanism may comprise a loop member that extends outwardly therefrom for enabling a user to support the grabber tool upon a hook member for storage.

In some embodiments, the arm support arrangement may comprise a handle mating portion and the handle mechanism may comprise a support mating portion. The handle and support mating portions are matable in these embodiments for attaching the arm support arrangement to the handle mechanism. In some embodiments, the support mating portion is configured to receive the handle mating portion. In some embodiments, the handle and support mating portions each comprise at least one fastener-receiving aperture for receiving at least one fastener for fastening the arm support arrangement to the handle mechanism.

In some embodiments, the arm support arrangement is S-shaped in three dimensions and comprises an arm-engaging angled portion and a support-to-fulcrum angled portion. In some embodiments, the arm-engaging angled portion extends in a first plane and the support-to-fulcrum portion extends in a second plane, the first and second planes being angled relative to one another about a radiused central segment. In some embodiments, the first plane extends obliquely relative to the arm axis such that the first plane extends through a grip end of the upper handle portion. In some embodiments, the arm-engaging angled portion comprises a first support segment, a second support segment and a radiused support segment extending intermediate the first and second support segments, the radiused support segment being configured for engaging the user's forearm.

In some embodiments, the first and second support segments flank outer portions of the user's forearm for further engaging the user's forearm and increasing the support function of the arm-engaging angled portion. In some embodiments, the first and second support segments are angled 40 degrees with respect to one another. In some embodiments, at least a portion of the arm-engaging angled portion comprises a padded exterior surface for providing a padded interface intermediate the user's forearm and the arm-engaging angled portion for enhancing comfort at the user's forearm during use of the grabber tool. In some embodiments, the support-to-fulcrum angled portion comprises a first angle segment, a second angle segment and a radiused angle segment extending intermediate the first and second angle segments, the first and second angle segments being angled 30 degrees with respect to one another. In some embodiments, the support-to-fulcrum angled portion is connected to the arm support angled portion by way of a radiused central segment.

The exemplary fishing tool embodiments also incorporate the arm support arrangement according to the presently disclosed subject matter, which arm support arrangement comprises a tubular body having at least three bends defining two planes and terminating in a tool-engaging end coextensive with or connected to or in line with an elongate arm portion, the distal end of which is configured to bear a load as exemplified by a fish load. In some embodiments, the arm support arrangement comprises a tubular body having an S-shape in three dimensions and comprises an upward slanting arm-engaging angled portion and a support-to-fulcrum angled portion, the latter of which is coextensive with or connected to or in line with an elongate arm portion substantially as earlier described.

A first of the two planes comprises an upward slanting arm-engaging angled portion opposite the tool-engaging end. The arm-engaging angled portion comprises one of the bends disposed between a pair of support segments. The bends cooperate to orient an axis of a user's forearm toward the tool-engaging end and the elongate arm portion, which tool-engaging end is attachable to either a fishing rod or a fishnet, the weight of which, whether with or without a fish or other load is directed downwardly such that the arm-engaging angled portion is directed upwardly toward the user's forearm about a fulcrum point intermediate the tool-engaging end and the arm-engaging angled portion. In some embodiments, the arm support arrangement may further comprise a fourth bend intermediate the fulcrum point and the tool-engaging end for orienting an axis of the tool-engaging end and elongate arm portion in parallel relation to the axis of the user's forearm.

### BRIEF DESCRIPTION OF THE DRAWINGS

Other features and objectives of the presently disclosed subject matter will become more evident from a consideration of the following brief descriptions of patent drawings.

FIG. 1 is a top perspective view of the grabber tool with arm support arrangement according to the presently disclosed subject matter showing the grabber tool with arm support arrangement in an extended configuration.

FIG. 2 is an exploded top perspective view of the grabber tool with arm support arrangement according to the presently disclosed subject matter showing the grabber tool with arm support arrangement in an extended, exploded configuration.

FIG. 3 is a lateral side view of the grabber tool with arm support arrangement according to the presently disclosed subject matter showing the grabber tool with arm support arrangement in an extended configuration and in an object-grabbing condition of use.

FIG. 4 is a top plan view of the grabber tool with arm support arrangement according to the presently disclosed subject matter showing the grabber tool with arm support arrangement in an extended configuration positioned adjacent a target object with object weight being directed into the page and a balancing force at the arm support arrangement being directed out of the page.

FIG. 5 is a bottom plan view of the grabber tool with arm support arrangement according to the presently disclosed subject matter showing the grabber tool with arm support arrangement in an extended configuration positioned adjacent the target object with object weight being directed out of the page and the balancing force at the arm support arrangement being directed into the page.

FIG. 6 is a top perspective view of the grabber tool with arm support arrangement according to the presently disclosed subject matter showing the grabber tool with arm support arrangement in an optional collapsed, stowage configuration.

FIG. 7 is a lateral side view of the grabber tool with arm support arrangement according to the presently disclosed subject matter showing the grabber tool with arm support arrangement in the optional collapsed, stowage configuration.

FIG. 8 is a top plan view of the grabber tool with arm support arrangement according to the presently disclosed subject matter showing the grabber tool with arm support arrangement in the optional collapsed, stowage configuration.

FIG. 9 is a proximal end view of the grabber tool with arm support arrangement according to the presently disclosed subject matter showing the grabber tool with arm support arrangement in the optional collapsed, stowage configuration.

FIG. 10 is an enlarged, bottom perspective view of a handle mechanism of the grabber tool with arm support arrangement according to the presently disclosed subject matter showing a trigger mechanism and arm support-mating structure thereof.

FIG. 11 is an enlarged, lateral side view of the handle mechanism of the grabber tool according to the presently disclosed subject matter.

FIG. 12 is an enlarged, distal end view of the handle mechanism of the grabber tool according to the presently disclosed subject matter.

FIG. 13 is a lateral side view of an elongate arm portion of the grabber tool according to the presently disclosed subject matter.

FIG. 14 is an exploded lateral side view of the elongate arm portion of the grabber tool according to the presently disclosed subject matter.

FIG. 15 is an enlarged distal end view of the elongate arm portion of the grabber tool according to the presently disclosed subject matter.

FIG. 16 is an enlarged lateral side view of a pincher mechanism of the grabber tool according to the presently disclosed subject matter.

FIG. 17A is an enlarged top plan view of the pincher mechanism of the grabber tool according to the presently disclosed subject matter depicting the pincher mechanism being operated to pinch or grab a generic object.

FIG. 17B is an enlarged top plan view of the pincher mechanism of the grabber tool according to the presently disclosed subject matter depicting the pincher mechanism being operated to release the generic object.

FIG. 18 is a first top perspective view of the arm support arrangement usable in combination with the grabber tool according to the presently disclosed subject matter depicting a fragmentary user forearm in positioned placement atop the arm support arrangement to show relative placement of the user forearm relative to the arm support arrangement.

FIG. 19 is a second top perspective view of the arm support arrangement usable in combination with the grabber tool according to the presently disclosed subject matter showing a distal support-to-fulcrum angled portion and a proximal arm-engaging angled portion thereof and depicting the angular relationship of a first support segment relative to a second support segment of the arm-engaging angled portion.

FIG. 20 is a distal end view of the arm support arrangement usable in combination with the grabber tool according to the presently disclosed subject matter.

FIG. 21 is a proximal end view of the arm support arrangement usable in combination with the grabber tool according to the presently disclosed subject matter.

FIG. 22 is a side view of the arm support arrangement of the grabber tool according to the presently disclosed subject matter depicting the angular relationship of the proximal arm-engaging angled portion relative to the support-to-fulcrum angled portion.

FIG. 23 is a side view of the arm support arrangement usable in combination with the grabber tool according to the presently disclosed subject matter depicting the angular relationship of the support-to-fulcrum angled portion relative to the arm-engaging angled portion.

FIG. 24 is a perspective view of the arm support arrangement usable in combination with the grabber tool according to the presently disclosed subject matter depicting the angular relationship of a first angle segment relative to a second angle segment of the support-to-fulcrum angled portion.

FIG. 25 is a bottom perspective view of the arm support arrangement usable in combination with the grabber tool according to the presently disclosed subject matter showing the support-to-fulcrum angled portion and the arm-engaging angled portion thereof.

FIG. 26 is a lateral side view of a modified handle mechanism attached to the arm support arrangement with a fragmentary elongate arm portion depicting a diagrammatic load at the distal end thereof and a balancing force being depicted at the arm support arrangement.

FIG. 27 is a top plan view of the modified handle mechanism attached to the arm support arrangement with the fragmentary elongate arm portion depicting a diagrammatic load at the distal end thereof directed into the page and the balancing force being depicted at the arm support arrangement being directed out of the page.

FIG. 28 is a first perspective view of the modified handle mechanism attached to the arm support arrangement with the fragmentary elongate arm portion depicting a generic fishing rod ensemble in line with the fragmentary elongate arm portion with a fish load at the distal end thereof and a balancing force being depicted at the arm support arrangement.

FIG. 29 is a second perspective view of the modified handle mechanism attached to the arm support arrangement with the fragmentary elongate arm portion depicting a generic fishnet ensemble in line with the fragmentary elongate arm portion with a net load at the distal end thereof and a balancing force being depicted at the arm support arrangement.

FIG. 30 is a top perspective view of a first fishnet tool shown in an extended configuration and outfitted with or connected to an arm support arrangement according to the presently disclosed subject matter.

FIG. 31 is a top perspective view of the first fishnet tool shown in a collapsed, stowage configuration and outfitted with or connected to an arm support arrangement according to the presently disclosed subject matter.

FIG. 32 is a first lateral side view of the first fishnet tool shown in an extended configuration and outfitted with or connected to an arm support arrangement according to the presently disclosed subject matter.

FIG. 33 is a second lateral side view of the first fishnet tool shown in an extended configuration and outfitted with or connected to an arm support arrangement according to the presently disclosed subject matter.

FIG. 34 is a top perspective view of a second fishnet tool shown in an extended configuration and outfitted with or connected to an arm support arrangement according to the presently disclosed subject matter.

FIG. 35 is a top perspective view of the second fishnet tool shown in a collapsed, stowage configuration and outfitted with or connected to an arm support arrangement according to the presently disclosed subject matter.

FIG. 36 is a first lateral side view of the second fishnet tool shown in an extended configuration and outfitted with or connected to an arm support arrangement according to the presently disclosed subject matter.

FIG. 37 is a second lateral side view of the second fishnet tool shown in an extended configuration and outfitted with or connected to an arm support arrangement according to the presently disclosed subject matter.

### DETAILED DESCRIPTION OF THE EMBODIMENTS

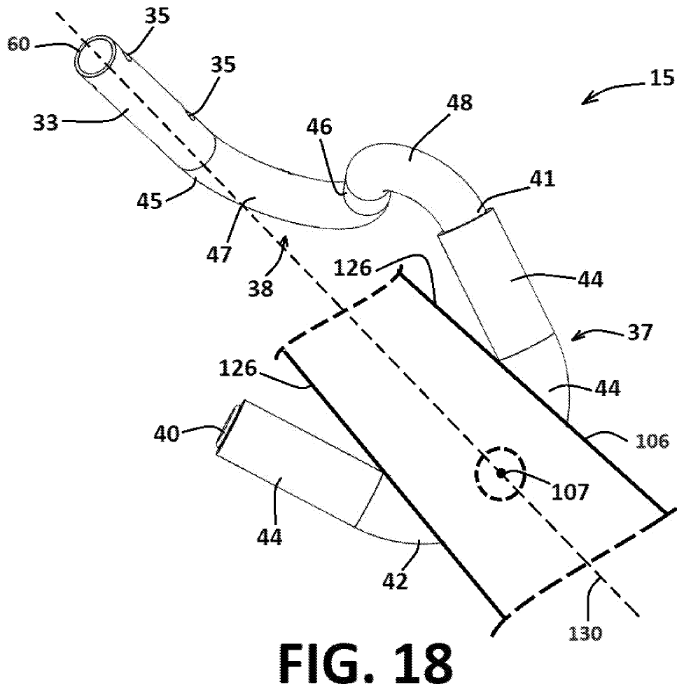

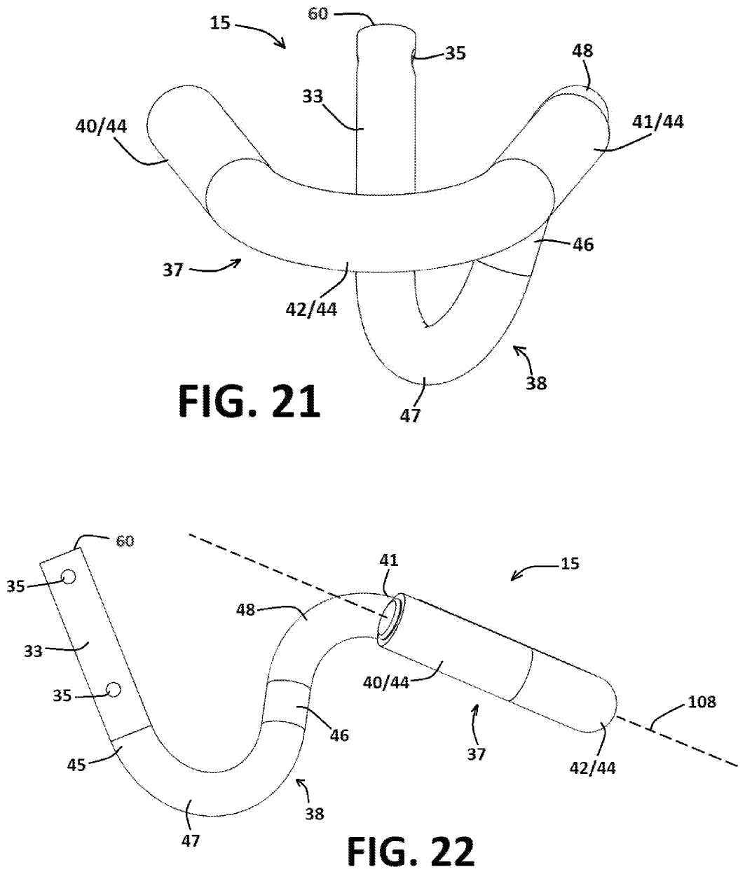

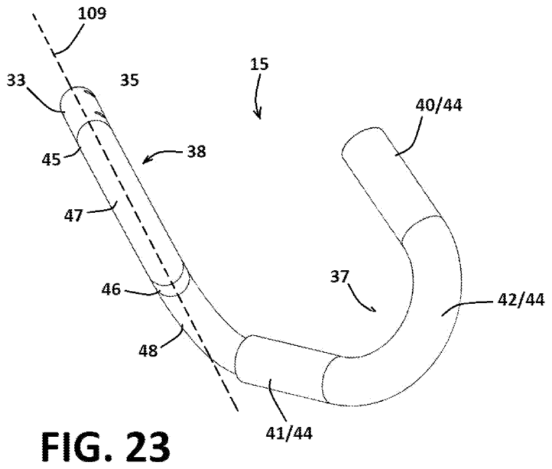

Referring now to the drawings with more specificity, the presently disclosed subject matter provides an arm support arrangement 15 for counterbalancing loads associated with tools incorporating the arm support arrangement 15. A first embodiment of the arm support arrangement 15 according to the presently disclosed subject matter is generally depicted in FIGS. 18 through 25. The arm support arrangement 15 according to the presently disclosed subject matter counterbalances a load associated with a load-bearing tool coextensive with or otherwise attached or connected to or in line with a tool-engaging end 60 of the arm support arrangement 15.

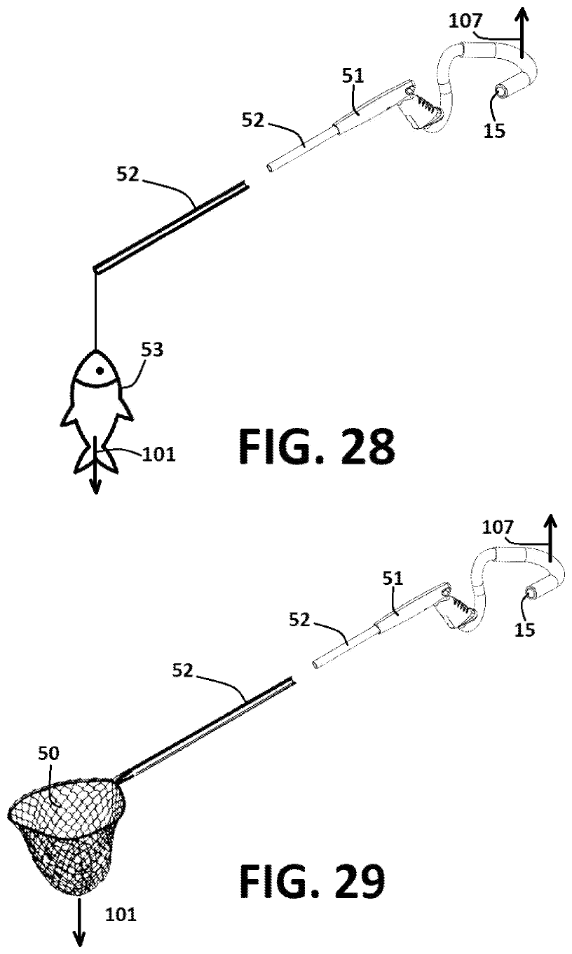

In some embodiments, the arm support arrangement 15 is usable in combination with a grabber tool 10, for example, and in some embodiments, the arm support arrangement is usable in combination with a fishing tool, for example. The exemplary fishing tool may be characterized by a fishing rod as at 49 or a fishnet as at 50 as generally depicted in FIGS. 28 and 29. The arm support arrangement 15 according to the presently disclosed subject matter may be said to be usable in combination with a select load-bearing tool, which select load-bearing tool may be selected from the group consisting of a grabber tool 10 and a fishing tool as exemplified by a fishing rod or fishnet 50.

In some embodiments, the arm support arrangement 15 according to the presently disclosed subject matter may be said to comprise a tubular body (of tubular metallic material construction) having at least three bends defining two planes and terminating in a tool-engaging end 60. Stated another way, the arm support arrangement 15 according to the presently disclosed subject matter may be said to comprise a tubular body having an S-shape in three dimensions comprising an upward slanting arm-engaging angled portion as at 37 and a support-to-fulcrum angled portion as at 38. A first of the two planes comprises the upward slanting arm-engaging angled portion 37 opposite the tool-engaging end 60. The arm-engaging angled portion 37 comprises one of the bends disposed between a pair of support segments. First and second support segments of the arm-engaging angled portion 37 are respectively referenced at 40 and 41. Intermediate the first and second support segments 40 and 41 is a bend or radiused support segment as at 42.

The bends or radiused support segments of the arm support arrangement 15 cooperate to orient an axis 130 of a user's forearm 106 toward the tool-engaging end 60. The tool-engaging end 60 is coextensive with or otherwise attachable to or in line with a load-bearing tool as exemplified by a grabber tool 10, fishing net 49 or fishnet 50 inherently having a tool weight as at 131. In some applications, the load-bearing tool may hold a generic object as depicted and referenced at 11, which object 11 has a weight or load as generally referenced at vector 101. The arm support arrangement 15 is coextensive with or attachable to or in line with a load-bearing tool at least a weight 131 of which is directed downwardly as at vector 132 such that the arm-engaging angled portion 37 is directed upwardly toward the user's forearm 106 about a fulcrum point intermediate the tool-engaging end 60 and the arm-engaging angled portion 37 thereby counterbalancing a load associated with the load-bearing tool as exemplified by loads 101 and/or 131. In some embodiments, a handle portion or handle mechanism is provided at the fulcrum point such at which point a user's hand grips the ensemble.

In some embodiments, the arm-engaging angled portion 37 extends in a first plane as at 108 and the support-to-fulcrum angled portion 38 extends in a second plane 109, which first and second planes 108 and 109 are obliquely angled relative to one another. In some embodiments, the first plane 108 extends obliquely relative to the axis 130 of the user's forearm 106 such that the first plane 108 extends through an end of the handle portion. In some embodiments, the handle portion may be exemplified by a handle mating portion as at 33 and in some embodiments the handle portion may be exemplified by handle grip portion as at 61. In some embodiments, the arm-engaging angled portion 37 of the arm support arrangement 15 comprises a first support segment 40, a second support segment 41 and a radiused support segment 42 extending intermediate the first and second support segments 40 and 41 such that the radiused support segment 42 is configured for engaging a first portion of the user's forearm 106.

In some embodiments, the first and second support segments 40 and 41 flank outer portions of the user's forearm 106 for further engaging outer portions of the user's forearm 106 and increasing the support function of the arm-engaging angled portion 37. The support-to-fulcrum angled portion 38 comprises a first angle segment as at 45, a second angle segment as at 46 and a radiused angle segment 47 extending intermediate the first and second angle segments 45 and 46. The support-to-fulcrum angled portion 38 of the arm support arrangement 15 is connected to the arm-engaging angled portion 37 by way of a radiused central segment 48. In some embodiments, the first angle segment 45 is coextensive with a handle mating portion 33 the end of which provides a tool-engaging end 60. In some embodiments, the first angle segment 45 is coextensive with a handle grip portion 61 the end of which provides a tool-engaging end 60. The tool-engaging end 60 is coextensive with or otherwise connectable to a select load-bearing tool as alluded to above.

In a first exemplary application, the arm support arrangement 15 according to the presently disclosed subject matter is usable in combination with a grabber tool 10 for generally enabling a user to grab objects from a distance greater than a user's natural arm length. A generic target object is depicted and referenced at 11, which generic target object 11 has a weight or load as generally referenced at vector 101. As prefaced above, similar tools are known in the art, and are commonly referred to as grabber tools, reacher tools, grabber reacher aids, trash grabbers, trash picker tools, plier tools, and the like. The distal ends of these types of grabber tools are generally outfitted with some type of pincher mechanism that is operable to pinch or grab an object so that the user may then reorient the tool and bring the grabbed object closer to the user's person without the need to bend, stand, reach, or climb upon secondary support structures to reach the targeted object.

As further introduced above, state-of-the-art tools of this type are typically configured such that the weight 101 of the object(s) so grabbed are directed into the user's hand and radiocarpal joint by way of the elongated arm portion of the tools, thereby placing stress or strain upon the hand and/or radiocarpal joint causing discomfort or possible injury to the user in many instances. The grabber tool 10 according to the presently disclosed subject matter helps shift moment away from the user's hand, the radiocarpal joint and peripheral anatomy toward the user's arm, which anatomy is better suited to provide static equilibrium with less strain at the user's hand and radiocarpal joint. The shift of the balancing force 107 thereby decreases discomfort at the hand/joint during usage and improving overall stability and usage of the grabber tool 10, particularly for user's who have experienced previous injury to the anatomical areas or users who have experienced a decline in structural strength in these anatomical areas, for example, the elderly.

To achieve this primary objective, the grabber tool 10 according to the presently disclosed subject matter comprises a centrally located handle mechanism 12, a distally extending elongate arm portion 13, a distally located pincher mechanism 14, and a proximally located arm support arrangement 15. The handle mechanism 12 is configured to be ergonomically received in a user's hand and in some embodiments is generally shaped in much the same manner as a pistol. More particularly, the handle mechanism 12 comprises an upper handle or barrel portion as at 16 and a lower handle portion or grip portion 17. The lower handle portion 17 is angled relative to the upper handle portion 16. The handle mechanism 12 further comprises a trigger mechanism as at 18. The trigger mechanism 18 generally extends intermediate the upper handle portion 16 and the lower handle portion 17 and is configured to enable the user's hand or fingers to selectively direct a trigger portion 19 of the trigger mechanism 18 toward the lower handle portion 17.

In some embodiments, the trigger mechanism 18 is pivotally connected to the upper handle portion 16 and pivots as at 113 about a trigger axis of rotation 102 when the trigger portion 19 is directed as at vector 111 toward the lower handle portion 17. A distal trigger portion 20 of the trigger mechanism 18 is directed as at vector 114 when the trigger portion 19 is directed as at vector 111. The distal trigger portion 20 is connected to a cable 21, which cable 21 extends through the distal arm end 22 of the upper handle portion 16 and through the distally extending elongate arm portion 13 to the distally located pincher mechanism 14. The elongate arm portion 13 extends distally along an arm axis 100 from the distal arm end 22 of the upper handle portion 16 and comprises a proximal handle end 26 and a distal pincher end 27.

In some embodiments, the distally extending elongate arm portion 13 may comprise a distal arm portion 28 comprising a substantially rigid material (e.g., a tubular metallic material construction) and a proximal arm portion 29 comprising a substantially rigid material (e.g., a tubular metallic material construction) interconnected by an optional pivot mechanism 30. The distal arm portion 28 comprises a pivot connector arm end 54 and the proximal arm portion 29 comprises a pivot connector arm end 55. In some embodiments, the pivot connector arm ends 54 and 55 mate with (female) opposed end-receiving portions 56 of the pivot mechanism 30, further optionally outfitted with push button release mechanism 57. The push button release mechanism 57 is operable to selectively lock the elongate arm portion 13 in an extended configuration and unlock the pivot mechanism 30 so as to be able to pivot the distal arm portion 28 relative to the proximal arm portion 29 to a collapsed, stowage configuration.

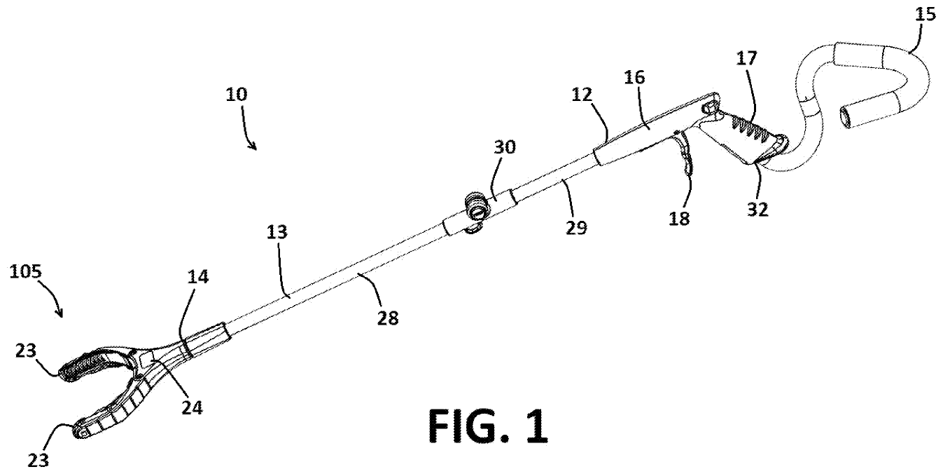

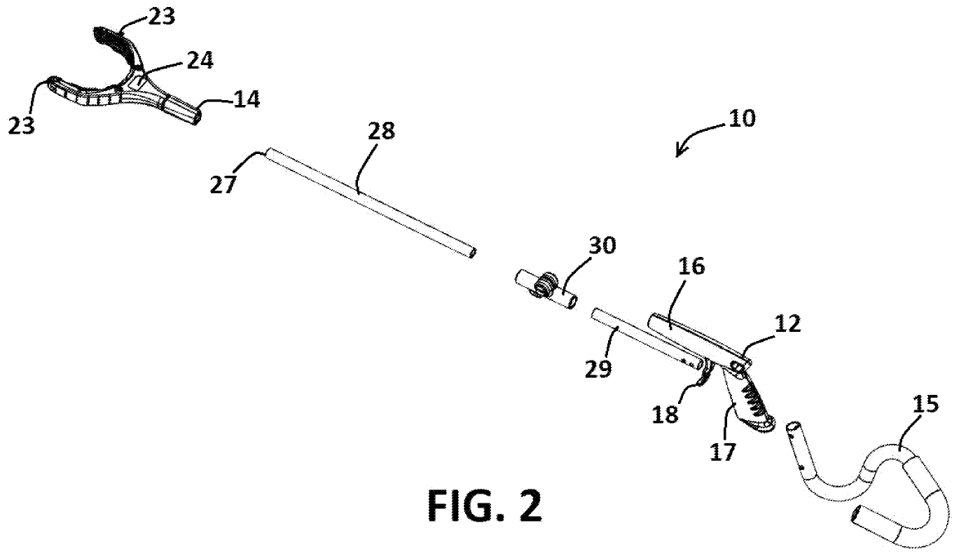

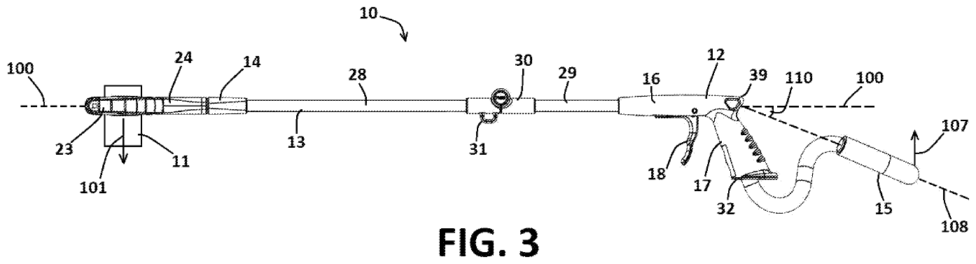

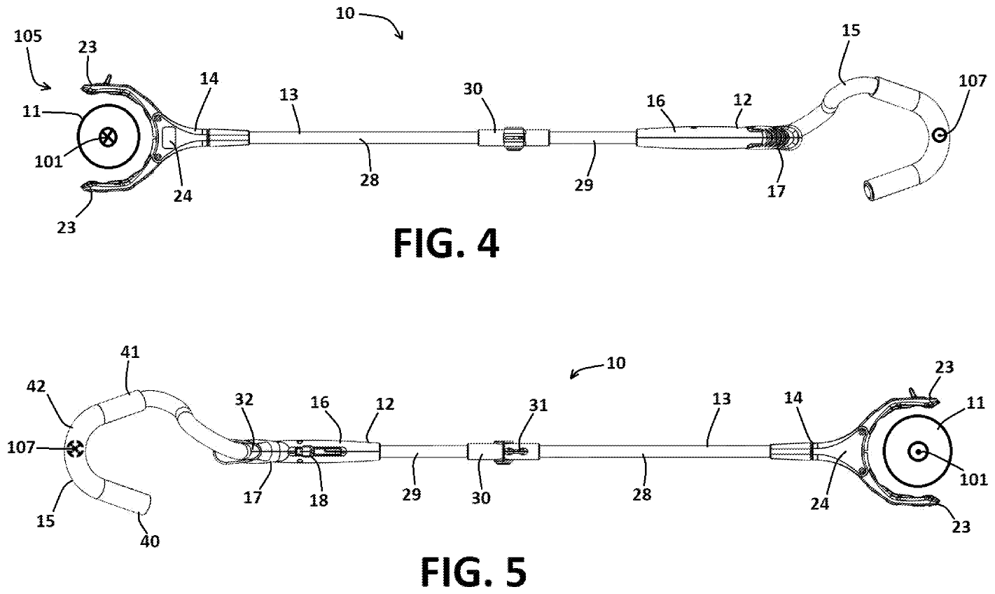

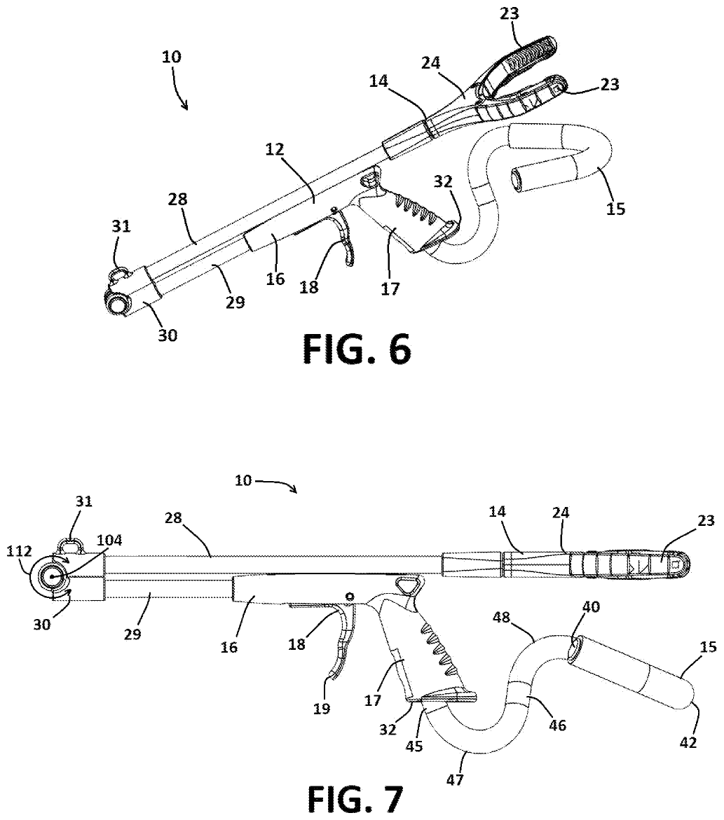

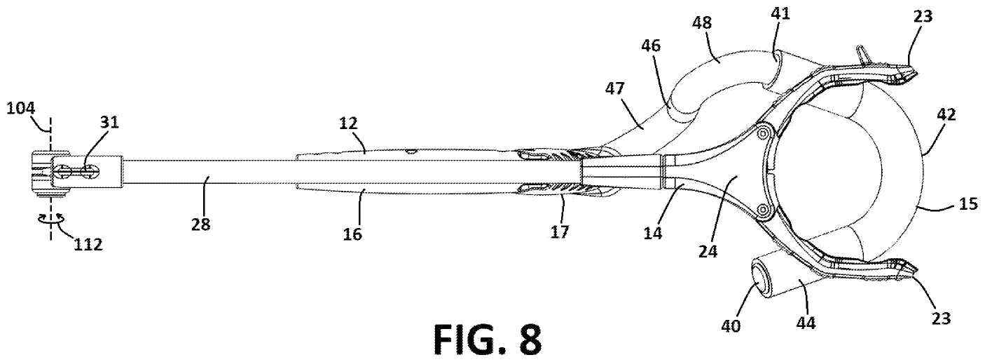

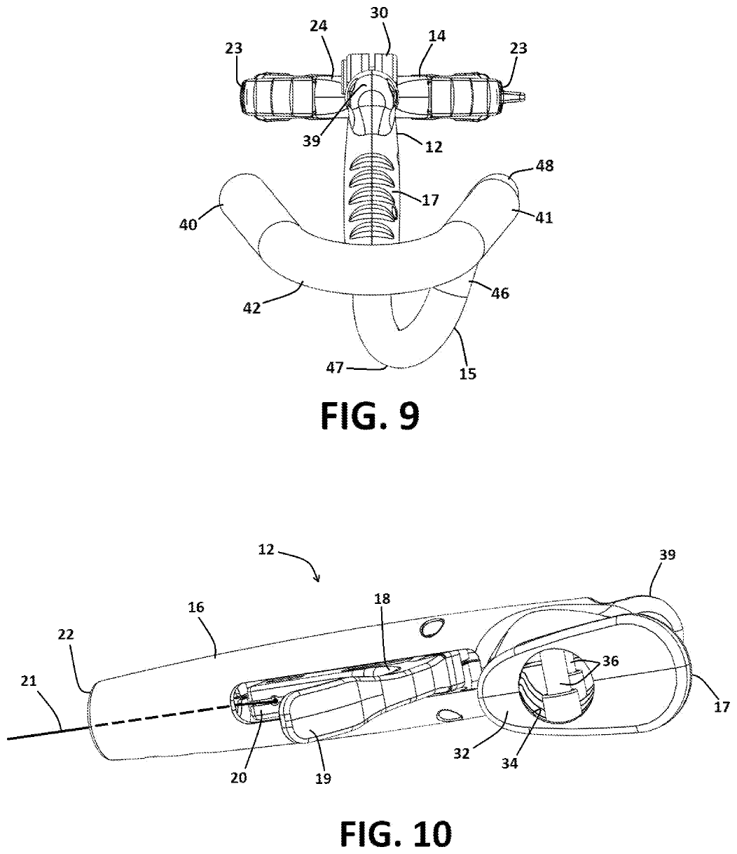

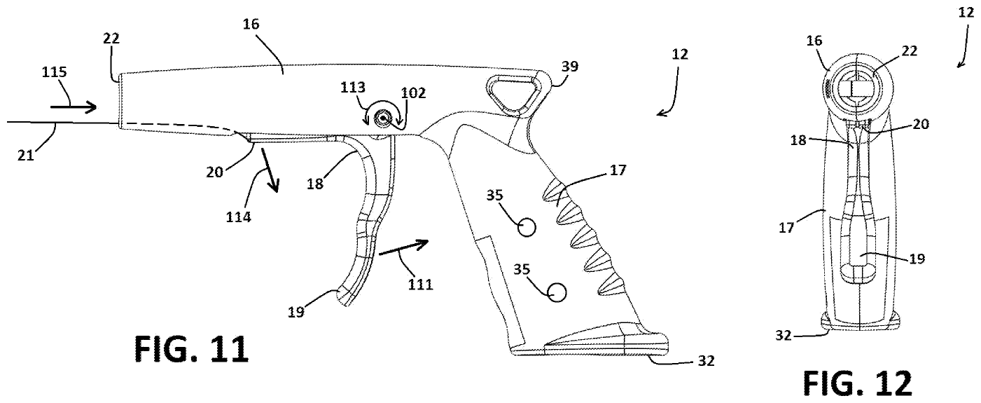

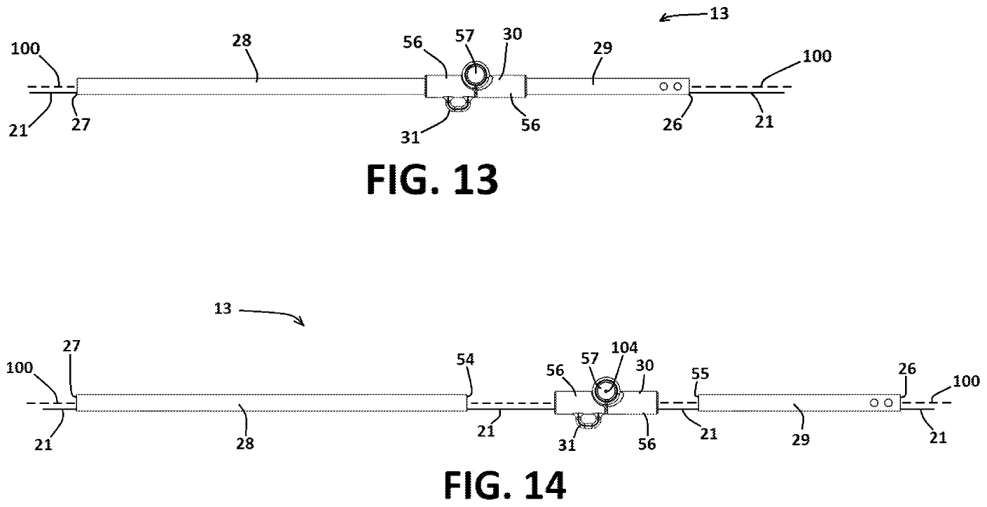

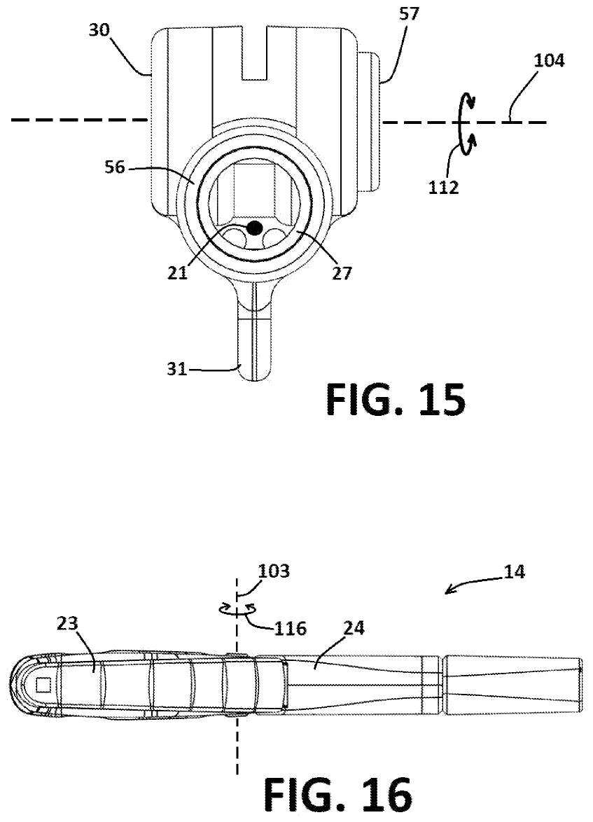

The extended configuration of the grabber tool 10 is generally depicted in FIGS. 1 through 5 and the collapsed, stowage configuration is generally depicted in FIGS. 6 through 9. The optional pivot mechanism 30 enables the user to rotate as at 112 the distal arm portion 28 and pincher end 27 about an arm axis of rotation 104 relative to the proximal arm portion 29 and handle end 26 thereby collapsing the grabber tool 10 into a relative more compact or shorter stowage configuration as generally depicted. In some embodiments, the pivot mechanism 30 may further comprise a loop member 31 that extends outwardly therefrom for enabling a user to support or hang the grabber tool 10 upon a hook member or similar other structure for storage.

In some embodiments, the distally located pincher mechanism 14 comprises laterally opposed grabber elements or arms as at 23. The laterally opposed grabber elements 23 are pivotally attached to a main body 24 of the pincher mechanism 14 and are pivotal as at arrow 116 about grabber arm axes of rotation as at 103. When the force-transferring cable 21 is directed as at vector 115 proximally toward the lower handle portion 17 by way of the trigger mechanism 18, the force-transferring cable 21 transfers the user-imparted trigger force 111 into the grabber elements 23 which then rotate as at arrows 117 about the grabber arm axes of rotation as at 103 to pinch or grab the object 11 as at vectors 118. In some embodiments, the grabber elements 23 may be inwardly outfitted with pliable, high friction materials and configurations as at 25 to better grip the object 11 as it is grabbed or pinched by the pincher mechanism 14.

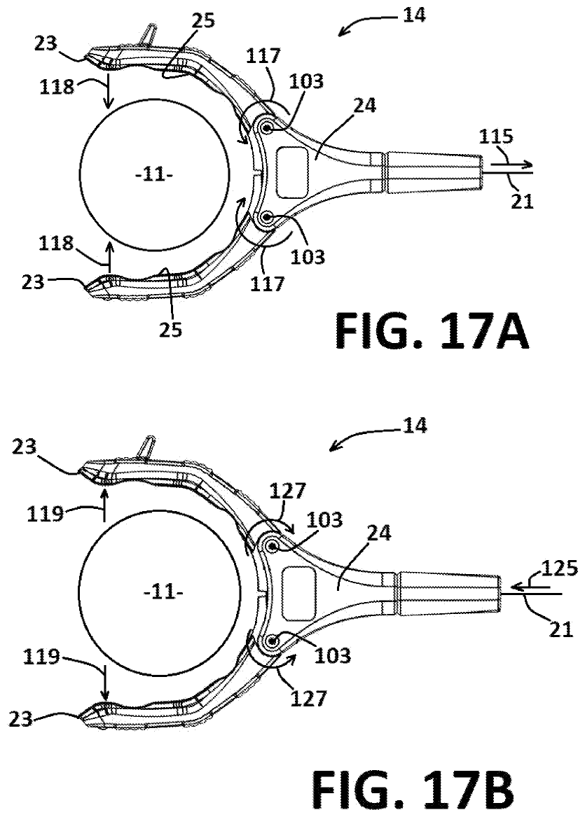

In some embodiments, the pincher mechanism 14 may comprise at least one internal spring mechanism (not specifically illustrated) within the main body 24 for returning the grabber elements 23, which then rotate as at arrows 127 about the grabber arm axes of rotation as at 103 to the open position 105 and directing 125 the cable 21 toward the pincher mechanism 14 as generally depicted and referenced in FIG. 17B when the trigger force 111 is removed from the trigger mechanism 18. It will thus be understood the pincher mechanism 14 operably extends from the pincher end 27 and is operatively coupled or connected to the trigger mechanism 18 by way of the force-transferring cable 21. The trigger mechanism 18 essentially functions to selectively close the pincher mechanism 14 for grabbing or pinching an object 11, and when the user releases the trigger portion 19, the grabber elements 23 return to the open position 105 for releasing the object 11 as at arrows 119.

The foregoing descriptions in support of the handle mechanism 12, the elongate arm portion 13, and the pincher mechanism 14 of the grabber tool 10 are fairly typical of state-of-the-art grabber tools. Central to the practice of the presently disclosed subject matter, and distinct from the state-of-the-art, is the arm support arrangement 15 or feature attached proximally relative to the handle mechanism 12, the elongate arm portion 13, and the pincher mechanism 14 of the grabber tool 10. The proximally located arm support arrangement 15 extends from a support end 32 of the lower handle portion 17 opposite the distally extending elongate arm portion 13 for essentially providing a fulcrum point at the handle mechanism 12. In this regard, the proximally located arm support arrangement 15 is configured to engage lower (or medial) portions of a user's forearm as at 106 for countering or balancing an object load or weight 101 at the pincher mechanism 14. The arm support arrangement 15 provides a structural basis for enabling static equilibrium by way of a directed balancing force 107 equal and opposite to the load or weight 101 into the user's forearm 106 in proximally spaced relation to the handle mechanism 12 for relieving anatomical strain at or about the user's hand and radiocarpal joint.

In some embodiments, the proximally located arm support arrangement 15 may further comprise a handle mating portion 33 and the handle mechanism 12 may comprise a support mating portion 34. The handle and support mating portions 33 and 34 are matable for attaching the arm support arrangement 15 to the handle mechanism 12. In some embodiments, a female support mating portion 34 is configured to receive a male handle mating portion 33. In some embodiments, the handle and support mating portions 33 and 34 each comprise at least one fastener-receiving aperture 35 for receiving at least one fastener 36 for fastening the arm support arrangement 15 to the handle mechanism 12. As illustrated, there are a series of four fastener-receiving apertures 35 formed in the handle mating portion 33 and two fastener-receiving apertures 35 formed in the support mating portion 34 for receiving two fasteners 36.

In some embodiments, the proximally located arm support arrangement 15 is generally and tortuously S-shaped in three dimensions and comprises a proximal arm-engaging angled portion 37 and a distal support-to-fulcrum angled portion 38. The proximal arm-engaging angled portion 37 extends in a first plane 108 and the distal support-to-fulcrum portion 38 extends in a second plane 109. The first and second planes 108 and 109 of the proximal arm-engaging angled portion 37 and the distal support-to-fulcrum portion 38 are angled relative to one another so as to position the proximal arm-engaging angled portion 37 and first plane 108 to extend obliquely at an angle of 20 to 25 degrees as at angle 110 relative to the arm axis 100. In some embodiments, the first plane 108 of the proximal arm-engaging angled portion 37 extends through a grip end 39 of the upper handle portion 16.

In some embodiments, the proximal arm-engaging angled portion 37 comprises a first support segment 40, a second support segment 41 and a radiused support segment 42 extending intermediate the first and second support segments 40 and 41. The radiused support segment 42 is configured for engaging a medial portion of the user's forearm 106 intermediate the proximal and distal portions thereof and directing balancing force 107 thereinto generally within a vertical plane extending through arm axis 100. In some embodiments, the first and second support segments 40 and 41 flank outer (anterior and posterior) portions 126 of the user's forearm 106 for further engaging the user's forearm 106 and increasing the support function of the arm-engaging angled portion 37.

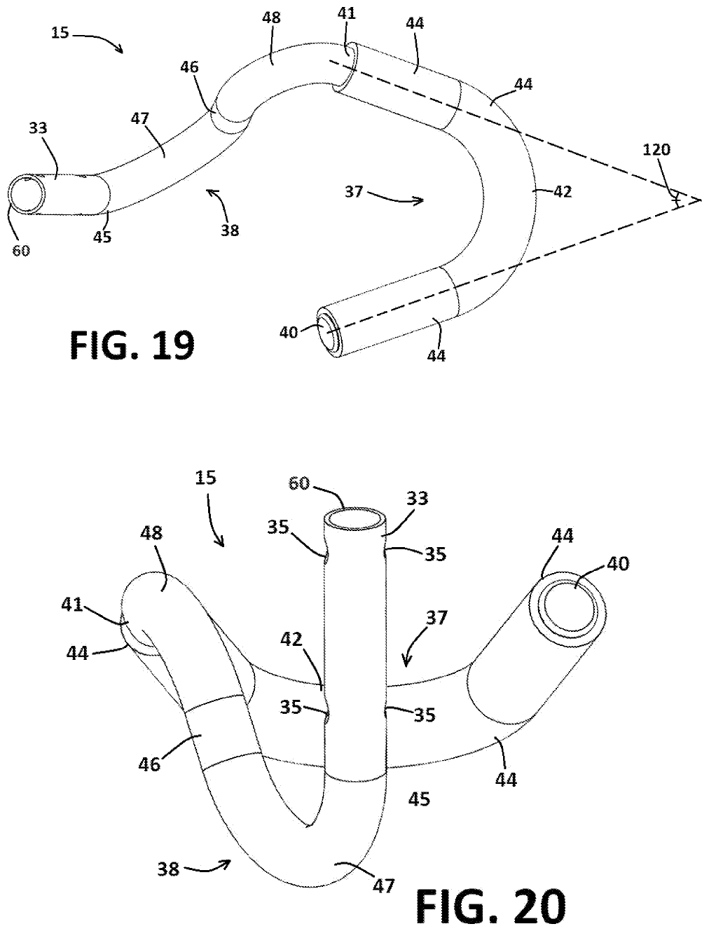

In some embodiments, the first and second support segments 40 and 41 are angled within a range of 30 to 50 degrees, and in some more particular embodiments 40 degrees with respect to one another as at angle 120 as generally depicted in FIG. 19. In some embodiments, at least a portion of the arm-engaging angled portion 37 comprises a padded exterior surface 44 for providing a padded interface intermediate the user's forearm 106 and the arm-engaging angled portion 37 for enhancing comfort at the user's forearm 106 when the balancing force 107 is directed thereinto during use of the grabber tool 10. The padded exterior surface(s) 44 not only help to disperse the balancing force 107 over a larger surface area, but also help stabilize the arm-engaging angled portion 37 at the user' forearm 106.

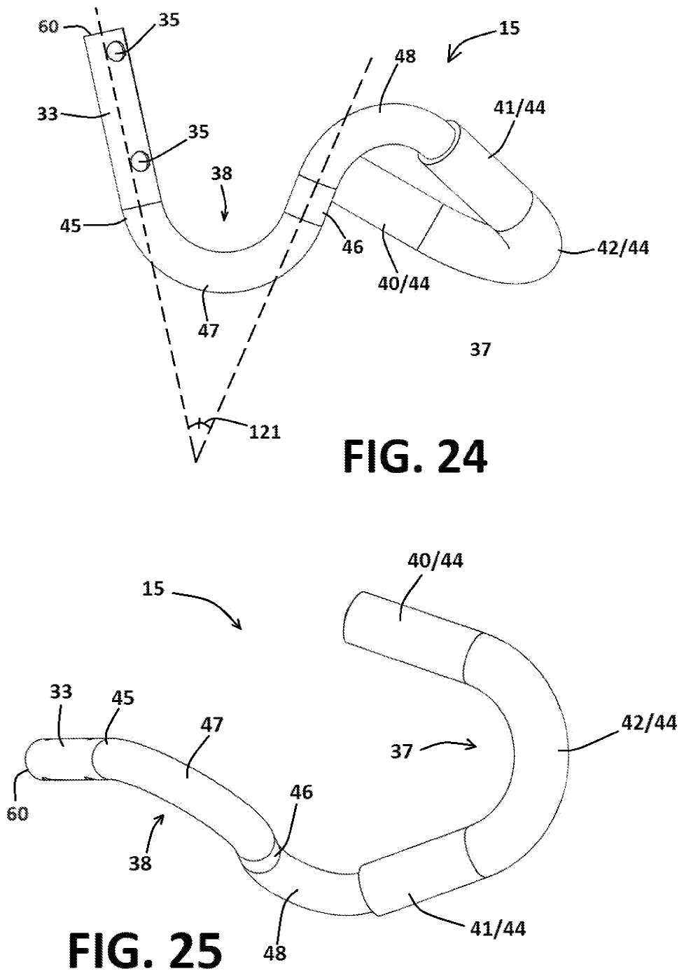

In some embodiments, the distal support-to-fulcrum angled portion 38 comprises a first angle segment 45 coextensive with the handle mating portion 33, a second angle segment 46, and a radiused angle segment 47 extending intermediate the first and second angle segments 45 and 46. In some embodiments, the first and second angle segments 45 and 46 are within a range of 25 to 45 degrees, and in some embodiments 35 degrees with respect to one another as at angle 121 in FIG. 24. In some embodiments, the distal support-to-fulcrum angled portion 38 is connected to the proximal arm support angled portion 37 by way of a radiused central segment 48 extending intermediate the second angle segment 46 of the distal support-to-fulcrum angled portion 38 and the second support segment 41 of the proximal arm support angled portion 37 thereby providing the three-dimensional tortuous and generally S-shaped arm support arrangement 15.

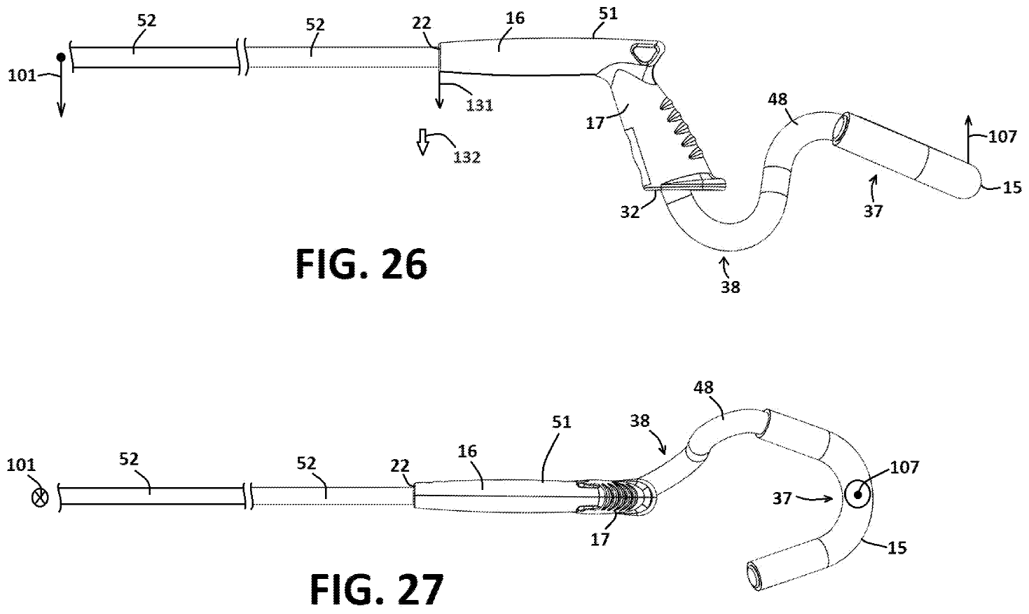

The presently disclosed subject matter further contemplates usage of the S-shaped arm support arrangement 15 in combination with any number of load-bearing tools, the distal ends of which bear a load or weight 101 as might be the case with the weight of a fish 53 on the end of a fishing rod 49 as generally depicted in FIG. 28 or a load 101 from a fishing net 50 or similar other net apparatus as generally depicted in FIG. 29. In this regard, it is contemplated the arm support arrangement 15 according to the presently disclosed subject matter may similarly transfer the balancing load 107 to a user's forearm 106 for reducing strain at the hand or radiocarpal joint in such applications. A modified handle mechanism 51 may be attached to the arm support arrangement 15 in much the same manner as handle mechanism 12 to provide a fulcrum point for the load balance function opposite an elongate arm portion 52 of such load-bearing tools. The handle mechanism 51, in certain embodiments, may, for example eliminate the trigger mechanism 18 otherwise associated with handle mechanism 12 as generally and comparatively depicted in FIGS. 26 and 27.

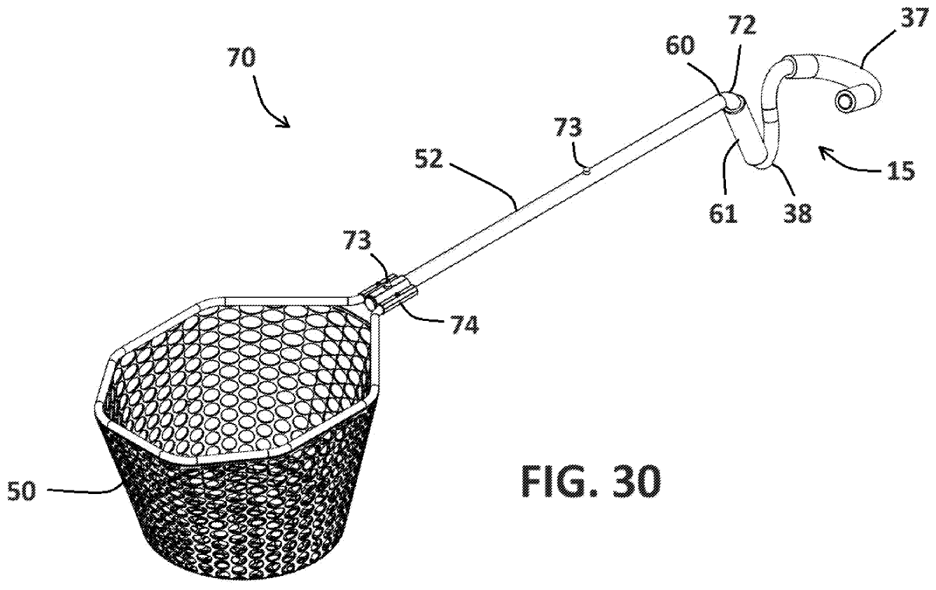

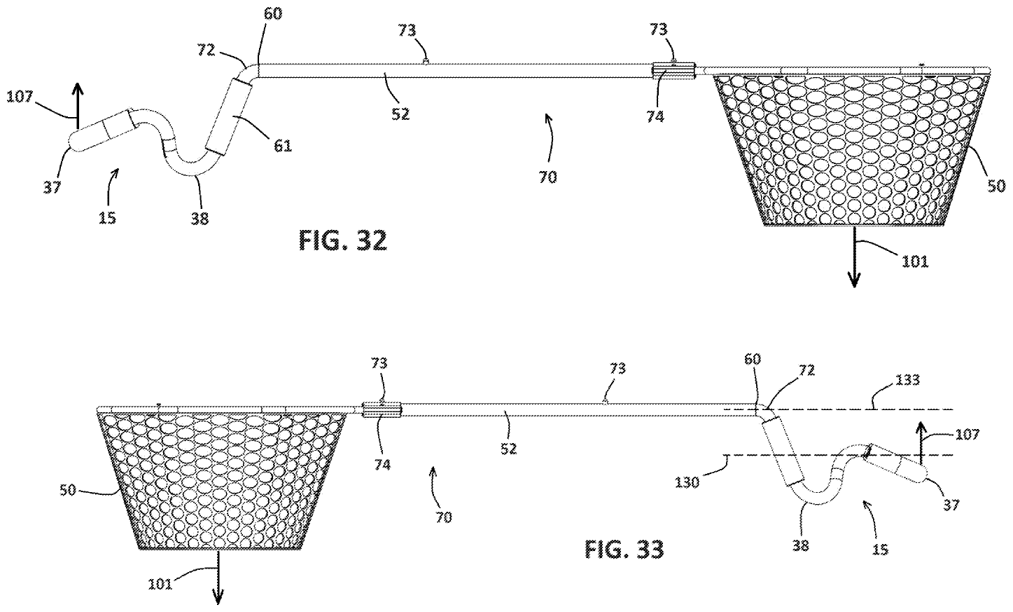

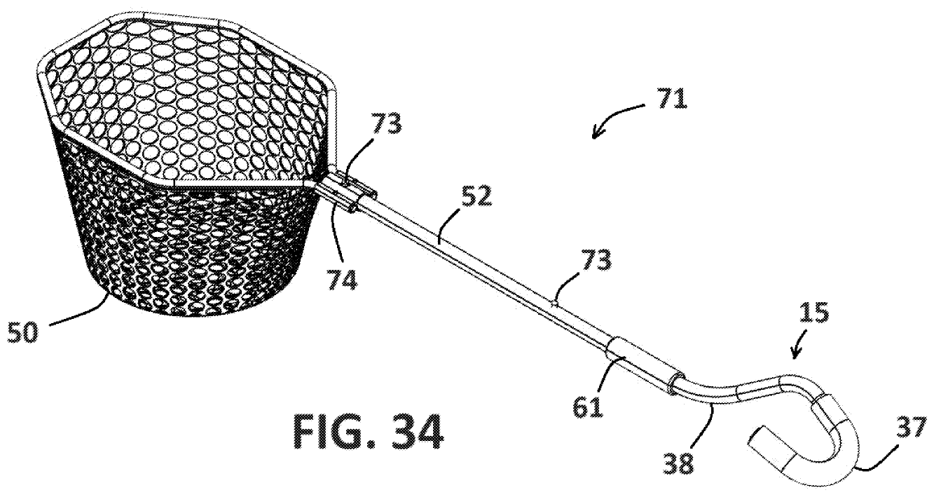

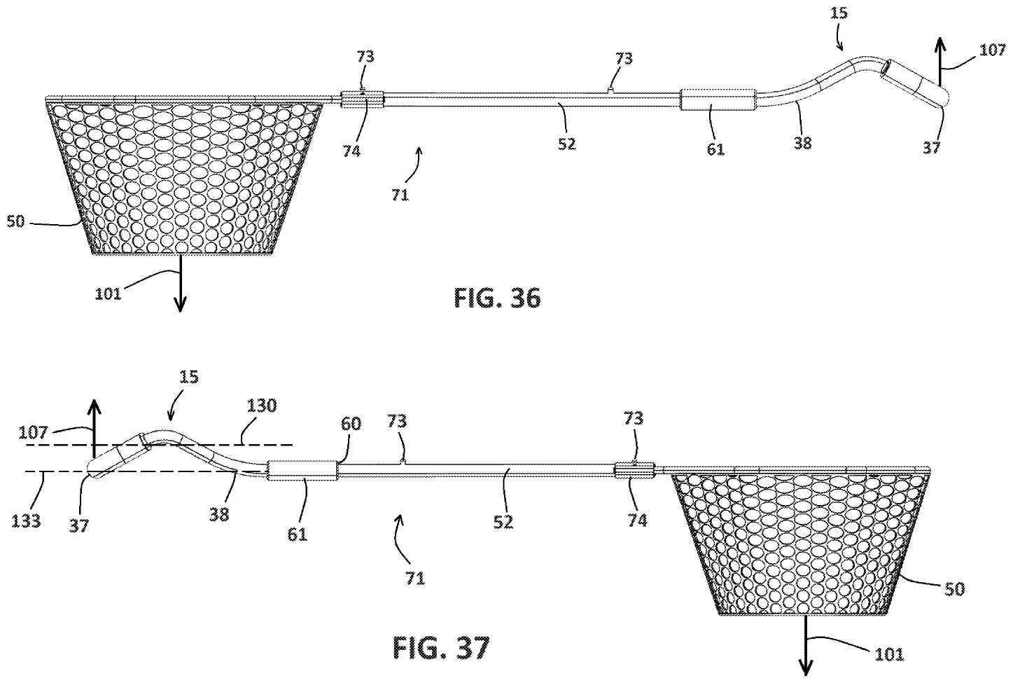

To help further illustrate a further exemplary application according to the presently disclosed subject matter, certain fishing tools are generally depicted and referenced in FIGS. 30 through 37. The fishing tools accordingly to the presently disclosed subject matter do not require a pincher mechanism and do not require a trigger mechanism. Accordingly, the fishing tools according to the presently disclosed subject matter eliminate the handle mechanism 12 and the pincher mechanism 14 but may include a fishnet 50 opposite the arm support arrangement 15. Two variations of fishing or fishnet tools are generally depicted and referenced at 70 and 71. The fishnet tool 70 comprises a handle grip portion 61 obliquely angled relative to the elongate arm portion 52 and the fishnet tool 71 comprises a handle grip portion 61 axially aligned with the elongate arm portion 52 as generally and comparatively depicted in FIGS. 32 and 33 versus FIGS. 36 and 37. In some embodiments, the arm support arrangement 15 comprises a fourth bend or radiused segment 72 intermediate the fulcrum point at the handle grip portion 61 and the tool-engaging end 60 for orienting an axis 133 of the tool-engaging end 60 in parallel or coaxial relation relative to the axis 130 of the user's forearm 106.

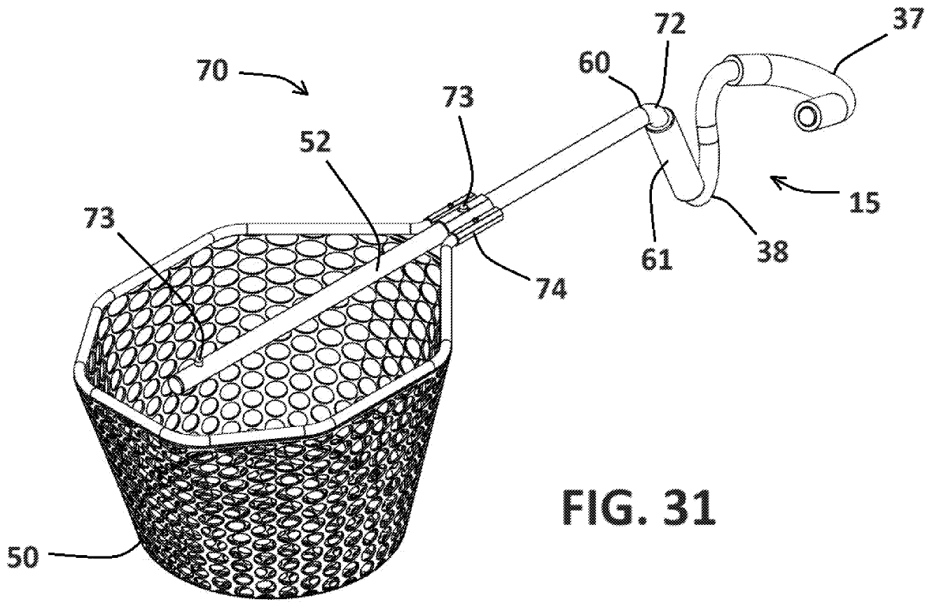

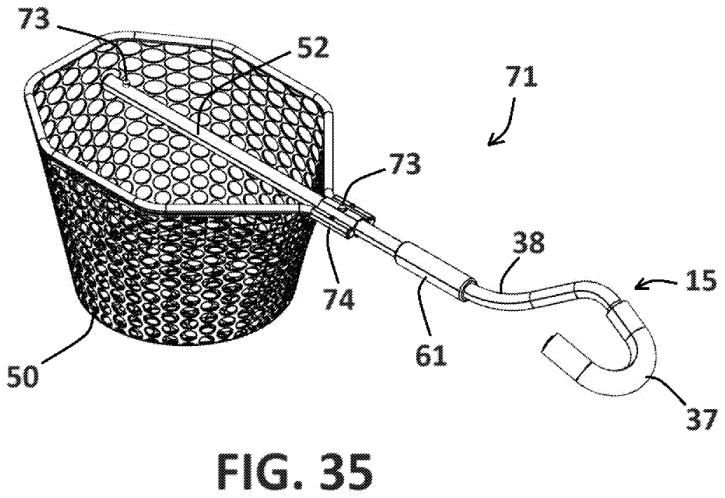

The fishnet tools 70 and 71 according to the presently disclosed subject matter may be configured to provide an extended configuration as generally and comparatively depicted in FIGS. 30, 32, 33, 34, 36, and 37 versus a collapsed, stowage configuration as generally and comparatively depicted in FIGS. 31 and 35. In some embodiments, the fishnet tools 70 and 71 comprise elongate arm portions 52 outfitted with proximally and distally located spring-biased buttons 73 matable with a button-receiving aperture formed in a neck portion 74 that slidably moves along the elongate arm portion 52 intermediate the extended configuration and the collapsed, stowage configuration. The buttons 73 may be selectively depressed to unlock the neck portion 74 from either the extended configuration or the collapsed, stowage configuration to allow the user to move the fishnet 50 intermediate the two configurations.

While the above descriptions contain much specificity, this specificity should not be construed as limitations on the scope of the presently disclosed subject matter, but rather as an exemplification thereof. In certain embodiments, the presently disclosed subject matter may be said to essentially teach or disclose an arm support arrangement comprising a tubular body having at least three bends defining two planes and terminating in a tool-engaging end. Stated another way, the arm support arrangement comprises a tubular body having an S-shape in three dimensions and comprises an upward slanting arm-engaging angled portion and a support-to-fulcrum angled portion.

A first of the two planes comprises an upward slanting arm-engaging angled portion opposite the tool-engaging end. The arm-engaging angled portion comprises one of the bends disposed between a pair of support segments. The bends cooperate to orient an axis of a user's forearm toward the tool-engaging end, which tool-engaging end is attachable to a load-bearing tool at least a weight of which is directed downwardly such that the arm-engaging angled portion is directed upwardly toward the user's forearm about a fulcrum point intermediate the tool-engaging end and the arm-engaging angled portion. The arm support arrangement thereby counterbalances a load associated with the load-bearing tool.

In some embodiments, the arm support arrangement comprises a handle portion at the fulcrum point. In some embodiments, the arm support arrangement comprises a fourth bend intermediate the fulcrum point and the tool-engaging end for orienting an axis of the tool-engaging end in parallel relation to the axis of the user's forearm. In some embodiments, the arm-engaging angled portion extends in a first plane and the support-to-fulcrum extends in a second plane, which first and second planes are angled relative to one another. In some embodiments, the first plane extends obliquely relative to the axis of the user's forearm such that the first plane extends through an end of the handle portion.

In some embodiments, the arm-engaging angled portion comprises a first support segment, a second support segment and a radiused support segment extending intermediate the first and second support segments. The radiused support segment is configured for engaging the user's forearm. In some embodiments, the first and second support segments flank outer portions of the user's forearm for further engaging the user's forearm and increasing the support function of the arm-engaging angled portion. In some embodiments, the support-to-fulcrum angled portion comprises a first angle segment, a second angle segment and a radiused angle segment extending intermediate the first and second angle segments. In some embodiments, the support-to-fulcrum angled portion is connected to the arm-engaging angled support angled portion by way of a radiused central segment.

The arm support arrangement according to the presently disclosed subject matter is usable in combination a select load-bearing tool, which select load-bearing tool is selected from the group consisting of a grabber tool and a fishing tool, the latter of which may include a fishing rod or a fishnet tool. In certain embodiments, the presently disclosed subject matter may be said to essentially teach or disclose a grabber tool for enabling a user to grab objects. The grabber tool according to the presently disclosed subject matter comprises a handle mechanism, and elongate arm portion, a pincher mechanism, and an arm support arrangement. The handle mechanism is configured to be ergonomically received in a user's hand and comprises an upper handle portion, a lower handle portion angled relative to the upper handle portion, and a trigger mechanism.

The elongate arm portion extends from a first handle end of the upper handle portion and comprises a proximal handle end and a distal pincher end. The pincher mechanism operably extends from the distal pincher end and is operatively coupled to the trigger mechanism via a force-transmitting mechanism as exemplified by a cable. The trigger mechanism is operable to selectively open and close the pincher mechanism via the force-transmitting mechanism. The arm support arrangement extends from the handle mechanism opposite the elongate arm portion for essentially providing a fulcrum point at the handle mechanism and is configured to engage a user's forearm for providing static equilibrium and countering a pincher mechanism load at the user's forearm and relieving stress at the user's hand.

In some embodiments, the elongate arm portion of the grabber tool may comprise or be outfitted with a pivot mechanism. The optional pivot mechanism enables the user to pivot the distal pincher end relative to the proximal handle end and collapse the grabber tool into a more compact or stowage configuration. In some embodiments, the pivot mechanism may comprise a loop member that extends outwardly from an outer surface thereof for enabling a user to support the grabber tool upon a hook member for storage. In some embodiments, the pivot mechanism may comprise opposed end-receiving portions extending from a centralized pivot mechanism, which end portions mate with distal and proximal arm portions of the elongate arm portion.

In some embodiments, the arm support arrangement may comprise a handle mating portion and the handle mechanism may comprise a support mating portion. The handle and support mating portions are matable in these embodiments for attaching the arm support arrangement to the handle mechanism. In some embodiments, the support mating portion is configured to receive the handle mating portion. In some embodiments, the handle and support mating portions each comprise at least one fastener-receiving aperture for receiving at least one fastener for fastening the arm support arrangement to the handle mechanism.

In some embodiments, the arm support arrangement is S-shaped in three dimensions and comprises an arm-engaging angled portion and a support-to-fulcrum angled portion. In some embodiments, the arm-engaging angled portion extends in a first plane and the support-to-fulcrum portion extends in a second plane, the first and second planes being angled relative to one another about a radiused central segment. In some embodiments, the first plane extends obliquely relative to the arm axis such that the first plane extends through a grip end of the upper handle portion. In some embodiments, the arm-engaging angled portion comprises a first support segment, a second support segment and a radiused support segment extending intermediate the first and second support segments, the radiused support segment being configured for engaging the user's forearm.

In some embodiments, the first and second support segments flank outer portions of the user's forearm for further engaging the user's forearm and increasing the support function of the arm-engaging angled portion. In some embodiments, the first and second support segments are angled 40 degrees with respect to one another. In some embodiments, at least a portion of the arm-engaging angled portion comprises a padded exterior surface for providing a padded interface intermediate the user's forearm and the arm-engaging angled portion for enhancing comfort at the user's forearm during use of the grabber tool. In some embodiments, the support-to-fulcrum angled portion comprises a first angle segment, a second angle segment and a radiused angle segment extending intermediate the first and second angle segments, the first and second angle segments being angled 30 degrees with respect to one another. In some embodiments, the support-to-fulcrum angled portion is connected to the arm support angled portion by way of a radiused central segment.

There is thus provided in accordance with another embodiment of the presently disclosed subject matter a grabber tool for enabling a user to grab objects. The grabber tool comprises a handle mechanism configured to be ergonomically received in a user's hand. The handle mechanism comprises a trigger mechanism configured to enable at least a portion of the user's hand to selectively direct at least a portion of the trigger mechanism in a first direction. The grabber tool further comprises an elongate arm portion. The elongate arm portion extends from the handle mechanism in a direction away from the first direction.

The grabber tool further comprises a pincher mechanism operably extending from the elongate arm portion. The pincher mechanism is operatively coupled to the trigger mechanism, the trigger mechanism being operable to selectively close the pincher mechanism. The grabber tool centrally further includes an arm support arrangement. The arm support arrangement extends from the handle mechanism opposite the elongate arm portion for providing a fulcrum point at the handle mechanism and is configured to engage a user's forearm for providing static equilibrium and countering a grabbed object load at the user's forearm.

In some embodiments, the elongate arm portion may comprise a pivot mechanism, the pivot mechanism for enabling the user to pivot a distal arm portion relative to a proximal arm portion of the elongate arm portion to collapse the grabber tool into a more compact configuration. In some embodiments, the pivot mechanism may comprise a loop member that extends outwardly therefrom for enabling a user to support the grabber tool upon a hook member for storage.

In some embodiments, the arm support arrangement may comprise a handle mating portion and the handle mechanism may comprise a support mating portion. The handle and support mating portions are matable in these embodiments for attaching the arm support arrangement to the handle mechanism. In some embodiments, the support mating portion is configured to receive the handle mating portion. In some embodiments, the handle and support mating portions each comprise at least one fastener-receiving aperture for receiving at least one fastener for fastening the arm support arrangement to the handle mechanism.

In some embodiments, the arm support arrangement is S-shaped in three dimensions and comprises an arm-engaging angled portion and a support-to-fulcrum angled portion. In some embodiments, the arm-engaging angled portion extends in a first plane and the support-to-fulcrum portion extends in a second plane, the first and second planes being angled relative to one another about a radiused central segment. In some embodiments, the first plane extends obliquely relative to the arm axis such that the first plane extends through a grip end of the upper handle portion. In some embodiments, the arm-engaging angled portion comprises a first support segment, a second support segment and a radiused support segment extending intermediate the first and second support segments, the radiused support segment being configured for engaging the user's forearm.

In some embodiments, the first and second support segments flank outer portions of the user's forearm for further engaging the user's forearm and increasing the support function of the arm-engaging angled portion. In some embodiments, the first and second support segments are angled 40 degrees with respect to one another. In some embodiments, at least a portion of the arm-engaging angled portion comprises a padded exterior surface for providing a padded interface intermediate the user's forearm and the arm-engaging angled portion for enhancing comfort at the user's forearm during use of the grabber tool. In some embodiments, the support-to-fulcrum angled portion comprises a first angle segment, a second angle segment and a radiused angle segment extending intermediate the first and second angle segments, the first and second angle segments being angled 30 degrees with respect to one another. In some embodiments, the support-to-fulcrum angled portion is connected to the arm support angled portion by way of a radiused central segment.

The fishing tool embodiments according to the presently disclosed subject matter comprises an arm support arrangement substantially as variously described and essentially comprises a tubular body having at least three bends defining two planes and terminating in a tool-engaging end coextensive with or connected to or in line with an elongate arm portion, the distal end of which is configured to bear a load most commonly associated with a fish. In some embodiments, the arm support arrangement comprises a tubular body having an S-shape in three dimensions and comprises an upward slanting arm-engaging angled portion and a support-to-fulcrum angled portion, the latter of which is coextensive with or connected to or in line with an elongate arm portion substantially as earlier described.

A first of the two planes comprises an upward slanting arm-engaging angled portion opposite the tool-engaging end. The arm-engaging angled portion comprises one of the bends disposed between a pair of support segments. The bends cooperate to orient an axis of a user's forearm toward the tool-engaging end and the elongate arm portion, which tool-engaging end is attachable to either a fishing rod or a fishnet, the weight of which, whether with or without a fish load is directed downwardly such that the arm-engaging angled portion is directed upwardly toward the user's forearm about a fulcrum point intermediate the tool-engaging end and the arm-engaging angled portion. In some embodiments, the arm support arrangement may further comprise a fourth bend intermediate the fulcrum point and the tool-engaging end for orienting an axis of the tool-engaging end and elongate arm portion in parallel relation to the axis of the user's forearm.

Accordingly, although the presently disclosed subject matter has been described by reference to certain embodiments, it is not intended that the novel arm support arrangement and associated applications and methods be limited thereby, but that modifications thereof are intended to be included as falling within the broad scope and spirit of the foregoing disclosures and the appended drawings. Insofar as the description above and the accompanying drawings disclose any additional subject matter that is not within the scope of the claims below, the embodiments are not dedicated to the public and the right to file one or more applications to claim such additional embodiments is reserved.

What is claimed is:

1. An arm support arrangement comprising:
a tubular body having at least three bends defining two planes and terminating in a tool-engaging end, a first of the two planes comprising an upward slanting arm-engaging angled portion opposite the tool-engaging end, the arm-engaging angled portion comprising one of the bends disposed between a pair of support segments;
the bends cooperating to orient an axis of a user's forearm toward the tool-engaging end, the tool-engaging end being in line with a load-bearing tool at least a weight of which is directed downwardly such that the arm-engaging angled portion is directed upwardly toward the user's forearm about a fulcrum point intermediate the tool-engaging end and the arm-engaging angled portion, the arm support arrangement thereby counterbalancing a load associated with the load-bearing tool.

2. The arm support arrangement according to claim 1 comprising a handle portion at the fulcrum point.

3. The arm support arrangement according to claim 1 comprising a fourth bend intermediate the fulcrum point and the tool-engaging end for orienting an axis of the tool-engaging end in parallel relation to the axis of the user's forearm.

4. The arm support arrangement according to claim 2 wherein the arm-engaging angled portion extends in a first plane and the support-to-fulcrum extends in a second plane, the first and second planes being angled relative to one another.

5. The arm support arrangement according to claim 4 wherein the first plane extends obliquely relative to the axis of the user's forearm such that the first plane extends through an end of the handle portion.

6. The arm support arrangement according to claim 1 wherein the arm-engaging angled portion comprises a first support segment, a second support segment and a radiused support segment extending intermediate the first and second support segments, the radiused support segment being configured for engaging the user's forearm.

7. The arm support arrangement according to claim 6 wherein the first and second support segments flank outer portions of the user's forearm for further engaging the user's forearm and increasing the support function of the arm-engaging angled portion.

8. The arm support arrangement according to claim 6 wherein the support-to-fulcrum angled portion comprises a first angle segment, a second angle segment and a radiused angle segment extending intermediate the first and second angle segments.

9. The arm support arrangement according to claim 6 wherein the support-to-fulcrum angled portion is connected to the arm-engaging angled support angled portion by way of a radiused central segment.

10. The arm support arrangement according to claim 1 comprising in combination a select load-bearing tool, the select load-bearing tool being selected from the group consisting of a grabber tool and a fishing tool.

11. An arm support arrangement comprising:
a tubular body having an S-shape in three dimensions and comprising an upward slanting arm-engaging angled portion and a support-to-fulcrum angled portion;
the tubular body defining two planes and terminating in a tool-engaging end, a first of the two planes comprising the arm-engaging angled portion opposite the end, the arm-engaging angled portion comprising one of the bends disposed between a pair of support segments;
the S-shape in three dimensions for orienting an axis of a user's forearm toward the tool-engaging end, the tool-engaging end being in line with a load-bearing tool at least a weight of which is directed downwardly such that the arm-engaging angled portion is directed upwardly toward the user's forearm about a fulcrum point intermediate the tool-engaging end and the arm-engaging angled portion, the arm support arrangement thereby counterbalancing a load associated with the load-bearing tool.

12. The arm support arrangement according to claim 11 comprising a handle portion at the fulcrum point.

13. The arm support arrangement according to claim 11 comprising a fourth bend intermediate the fulcrum point and the tool-engaging end for orienting an axis of the tool-engaging end in parallel relation to the axis of the user's forearm.

14. The arm support arrangement according to claim 12 wherein the arm-engaging angled portion extends in a first plane and the support-to-fulcrum extends in a second plane, the first and second planes being angled relative to one another.

15. The arm support arrangement according to claim 14 wherein the first plane extends obliquely relative to the axis of the user's forearm such that the first plane extends through an end of the handle portion.

16. The arm support arrangement according to claim 11 wherein the arm-engaging angled portion comprises a first support segment, a second support segment and a radiused support segment extending intermediate the first and second support segments, the radiused support segment being configured for engaging the user's forearm.

17. The arm support arrangement according to claim 16 wherein the first and second support segments flank outer portions of the user's forearm for further engaging the user's forearm and increasing the support function of the arm-engaging angled portion.

18. The arm support arrangement according to claim 16 wherein the support-to-fulcrum angled portion comprises a first angle segment, a second angle segment and a radiused angle segment extending intermediate the first and second angle segments.

19. The arm support arrangement according to claim 16 wherein the support-to-fulcrum angled portion is connected to the arm-engaging angled support angled portion by way of a radiused central segment.

20. The arm support arrangement according to claim 11 comprising in combination a select load-bearing tool, the select load-bearing tool being selected from the group consisting of a grabber tool and a fishing tool.
